(19) United States
(12) Patent Application Publication
(10) Pub. No.: US 2003/0162300 A1
(43) Pub. Date: Aug. 28, 2003

(54) Galactomannan-oligosaccharides and methods for the production and use thereof

(76) Inventors: Markwart Kunz, Worms (DE); Manfred Vogel, Neuleiningen (DE); Michael Klingeberg, Grunstadt (DE); Eva Ludwig, Leimen (DE); Mohammad Munir, Kindenheim (DE); Frank Rittig, Grunstadt (DE)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/168,044

(22) PCT Filed: Dec. 12, 2000
(86) PCT No.: PCT/EP00/12574

(30) Foreign Application Priority Data
Dec. 18, 1999 (DE) 199 61 182.3

(51) Int. Cl. A23K 1/00

(52) U.S. Cl. 436/101; 426/52; 426/658

(57) ABSTRACT

The invention relates to methods for the hydrolysis of galactomannan compounds and various uses of the hydrolysate.

The subject matter of the present invention relates to galactomanno-oligosaccharides and a method for the production and use thereof.

There is a constant need for isolating active ingredients and/or additives for food products and/or medications from renewable raw materials. This is attributable both to the fact that raw materials isolated from natural sources are readily accepted by the consumer and to the fact that they can be processed in an environmentally friendly manner. Mannans and their derivatives, such as glucomannan and galactomannan, are such natural raw materials. Mannans are polyoses which are synthesized from mannose rather than from glucose units. The mannose chains comprise β-1,4-linked mannose units. In addition to the β-1,4-linked mannose units, galactomannans also comprise galactose units linked to α-1,6, i.e., they comprise both mannose and galactose building blocks. Galactomannans of this type are available in the form of guar gum, cassia gum, and carob seed flour and are used, for examples, as thickening agents in the food industry and as tableting aids in the pharmaceutical industry (Industrial Gums, R. L. Whistler and J. N. BeMiller, eds., 3rd edition, 1992, Academic Press, N.Y.). Galactomannans from different sources differ mainly in their relative mannose and galactose content.

To produce raw materials suitable for the production of food products, polyoses are frequently disintegrated into smaller units. Thus, it is known, for example, to hydrolyze polysaccharides by means of diluted acids at different temperatures. The hydrolysis of galactomannans leads to a mixture of the monomers, i.e., mannose and galactose.

It is known that an endo-13-mannanase (E.C. 3.2.1.78) isolated from Aspergillus niger can enzymatically hydrolyze galactomannan (H. Uhlig, Enzyme arbeiten für uns [Enzymes are working for us], Carl Hanser Verlag Munich, Vienna 1991). But this enzyme is not able to hydrolyze the galactomannan from guar gum, and galactomannan is only partially hydrolyzed from carob seed meal. Thus, the suitability of galactomannans for undergoing hydrolysis may differ depending on the source from which they are obtained.

Ajisaka et al. (Carbohydrate Research 270 (1995), pp. 123-130) described a method which makes possible the enzymatic synthesis of mannobiose and mannotriose by means of an α-mannosidase isolated from Aspergillus niger. This synthesis which is carried out by means of a reversal of the normal hydrolysis reaction leads to technically unacceptable yields of approximately 2%. The products do not contain any galactose units.

K. Newman (Biotechnology in the Feed Industry, Proc. of Alltech's 20th Symposium (1994), pp. 167-174) described a glucomannoprotein complex which binds specifically the mannose-specific lectins of pathogenic microorganisms. Since this product contains no galactose units, it cannot mediate a binding to galactose-specific microbial lectins.

Thus, the technical problem to be solved by the present invention is to make available substances that can be manufactured from galactomannan and a method for their production which can be advantageously used in the pharmaceutical industry and in food technology.

The technical problem is solved by the present invention by making available a method for the production of mannose- and galactose-containing oligosaccharides from galactomannans, according to which an aqueous solution or suspension of the galactomannan is produced, which is hydrolyzed by means of an enzymatic activity that is mediated by bacteria, in particular by using an enzymatic agent obtained from bacteria, and a mixture of mannose- and galactose-containing oligosaccharides with a degree of polymerization (DP) of <15, in particular of 2 to 7, is obtained. The present invention also solves the basic problem by making available galactomanno-oligosaccharides which can be produced as described and which comprise β-1,4-linked mannose units and galactose units linked to α-1,6 with a degree of polymerization of <15, in particular of 2 to 7. Surprisingly, these galactomanno-oligosaccharides offer the advantage that when used in or as food and other products consumed* and drugs, they make it possible to protect against and to treat diseases and they can serve to improve the state of health.

The galactomanno-oligosaccharides according to the present invention are particularly marked by the fact that they lower the glycemic index of foods, fight and/or prevent infectious diseases by preventing or reducing the adhesion of pathogenic microorganisms to human and animal epithelial cells, fight and/or protect against inflammatory chronic intestinal disorders, counteract the development of intestinal cancer or colon carcinomas and/or fight such diseases, strengthen the immunodefense system against general infections, modulate the immunodefense system and thus fight and/or prevent inflammatory diseases, and improve the calcium absorption and thus counteract, in particular, osteoporosis.

In the context of the present invention, the term disease is defined as a disorder of the vital processes in organs or in the entire organism which entails subjectively felt or objectively detectable physical, mental, or psychological changes. In the context of the present invention, the term disease also includes deficiencies. *Translator's note: ‘Nahrungsmittel’ and ‘Lebensmittel’ are synonyms for food products. ‘Genussmittel’ is an untranslatable term, the literal translation into English is pleasure or enjoyment products, such as chocolate, coffee, tea, tobacco, and alcohol, i.e., stimulants without a nutritional value. Hereinafter, these will be referred to as ‘enjoyment products’.

In the context of the present invention, the term active ingredient is defined as a substance which elicits a biological effect in living organisms or parts thereof. A medicinal agent is defined as an active ingredient which can serve to prevent, alleviate, cure, or diagnose diseases. A drug is defined as a specific formulation of medicinal agents for administration to humans or animals.

In the context of the present invention, a food product is defined as a product which primarily serves to maintain the life functions while an “enjoyment product” defines a product which, on consumption, primarily increases the consumer's well-being.

Thus, the present invention relates to mannose- and galactose-containing oligosaccharides, also known as galactomanno-oligosaccharides, with a degree of polymerization (DP) of <15, in particular with a degree of polymerization of 2 to 7, in which the mannose units β-1,4 and the galactose units are linked to the mannose units α-1,6. The galactomanno-oligosaccharides are stable against the hydrolytic conditions prevalent in the mouth, stomach, and small intestine and are therefore able to reach the colon substantially unmodified, where they can release their desired health-promoting effect.

Not only are the galactomanno-oligosaccharides according to the present invention themselves resistant to the hydrolytic condition in the small intestine, they additionally even inhibit the a-glucosidases (glucoamylase/maltase and saccharase/isomaltase) located in the mucous membrane. Thus, according to the present invention, they can be used to lower the glycemic index of “enjoyment products” and food products.

According to the present invention, the galactomanno-oligosaccharides described in this invention are also able to reduce or prevent the adhesion or pathogenic microorganism to epithelial cells and thus to protect against and treat infectious diseases. Furthermore, the galactomanno-oligosaccharides according to the present invention stimulate the mucus secretion from the goblet cells in the intestine and therefore have a positive influence on the course of various intestinal diseases.

As already mentioned earlier, the galactomanno-oligosaccharides according to the present invention are not hydrolyzed in the small intestine but reach the colon substantially unmodified, where the microorganisms that are present in that region subsequently ferment them to form short-chain fatty acids, in particular, butyrate. Since the pH value is lowered as a result of this fermentation, the conditions necessary for the life existence of harmful microorganisms, such as clostridia, deteriorate while the life conditions for beneficial bifido bacteria and lactobacilli are improved. Thus, the galactomanno-oligosaccharides according to the present invention have prebiotic effect. Owing to the increased formation of butyrate described above, the formation and the growth of colon carcinoma can be reduced and/or prevented.

Furthermore, the galactomanno-oligosaccharides according to the present invention are also beneficial in that they improve the absorption of calcium from inorganic food components in the intestinal region and can therefore be used, in particular, to protect against and to prevent osteoporosis, in particular primary osteoporosis, such as postmenopausal or senile osteoporosis, or secondary osteoporosis.

And finally, another advantage of the galactomanno-oligosaccharides according to the present invention relates to the fact that they interact directly with the cellular immune system and are thus able, on the one hand, to strengthen the immunodefense and, on the other hand, modulate the immunological response, thus making it possible for inflammatory processes to be reduced and/or suppressed.

Thus, the present invention also relates to “enjoyment products” or food products and so-called functional foods that contain the galactomanno-oligosaccharides according to the present invention. Such food products include, for example, dairy products, such as butter, yogurt, quark*, baked goods, powdered soups and sauces, various spreads for breads, margarine, cooking fats and shortenings, spice mixtures, jams, nonalcoholic beverages, etc. “Enjoyment products” include, for example, hard or soft caramels, chewing gums, chocolate, muesli bars, cookies and crackers, ice creams, meringues and gummi bears, dragecs, alcoholic and nonalcoholic beverages, etc.

The present invention also relates to drugs which contain the galactomanno-oligosaccharides according to the present invention, potentially together with pharmacologically suitable vehicles, additives, or auxiliary agents, in a pharmaceutically effective quantity. Such vehicles, auxiliary agents, or additives include, for example, lubricants, separating agents, thickeners, stabilizers, emulsifying agents, preservatives, lecithin, intensive sweeteners, sweetening agents, colorants, taste-bearing substances, flavor compounds, bulking agents, i.e., fillers, etc.

The drugs may be available, for example, in the form of lozenges, capsules, tablets, dragees, suppositories, solutions, suspensions, emulsions, solutions for injection, solutions for infusion, drops, juices and syrups, ointments, creams, gels, aerosols, inhalants, or other conventional forms of presentation.

This invention also relates to galactomanno-oligosaccharides according to the present invention for use in a process for the surgical and therapeutic treatment of the human or animal body. In addition, this invention also relates to the use of the galactomanno-oligosaccharides according to the present invention in the prevention or treatment of diabetes mellitus II, *‘Quark’ is similar to smooth cottage cheese. infectious diseases, intestinal diseases, colon carcinomas, inflammatory diseases, and osteoporosis as well as to the use of the galactomanno-oligosaccharides according to the present invention in the production of a drug for the purposes mentioned above.

In addition, this invention also relates to methods for the production of the galactomanno-oligosaccharides according to the present invention, according to which an aqueous solution or suspension of a galactomannan is produced from a galactomannan-containing raw material, in particular guar gum, for example, guar meal, cassia gum, or carob seed meal, which is hydrolyzed by means of an enzymatic activity that is mediated by bacteria, in particular by using an enzymatic agent obtained from bacteria, and an aqueous solution of a mixture of mannose- and galactose-containing oligosaccharides with a degree of polymerization of <15, preferably of 2 to 7, is obtained. From the aqueous product solution, a dry mixture of the product can be obtained, for example, by means of spray drying.

Thus, surprisingly, this invention teaches that it is possible by means of an enzymatic activity mediated by bacteria to hydrolyze galactomannans from these raw materials obtained, for example, from guar gum, cassia gum, and carob seed meal, to form the galactomanno-oligosaccharides according to the present invention with equally high efficiency.

The concentration of galactomannans in the aqueous solution is preferably 1 to 5%, the pH value is preferably 5 to 8, and the temperature of the solution is preferably 30° C. to 40° C.

In the context of the present invention, an enzymatically effective agent is defined as a completely or partially purified enzyme or a raw extract of bacteria, in particular bacillus cells or live or dead bacteria, which can hydrolyze galactomannans to form, in particular, galactomanno-oligosaccharides with a degree of polymerization of <15, preferably of 2 to 7. Raw extracts can be obtained by means of conventional methods, such as mechanical decomposition processes, for example, with a ball mill or a French press, chemical or electrical decomposition processes, for example, by generating electrical fields, or ultrasound treatments.

According to one particularly preferred embodiment of the present invention, bacteria of the Bacillus subtilis type, in particular a Bacillus subtilis strain with the accession number DSM 13182, deposited on Dec. 6, 1999, with the German Collection of Microorganisms and Cell Cultures in Braunschweig [Deutsche Sammlung von Mikroorganismen und Zellkulturen, DSM], are used.

It goes without saying that the bacteria used may also be naturally existing or gene-manipulated bacteria, in particular bacilli. The bacteria used may, for example, have a stability against certain antibiotics, thus making it possible to produce the enzymatically effective agent in an especially simple manner. The enzyme originating from the bacteria may be of natural origin or have a wild-type amino acid sequence, but it may also have amino acid variations with respect to the naturally existing enzyme, for example, amino acid deletions, insertions, inversions, exchanges, or additions, or even uncommon amino acids. The enzyme may optionally also have undergone modifications, such as glycosylations or similar processes. The enzyme can also be present in the form of a fusion protein with another protein or peptide or in the form of an enzyme fragment as long as it is able to hydrolyze the galactomannans to form the products mentioned above.

The present invention also relates to the use of the enzymatically effective agent for the hydrolysis of the galactomannan, with the possibility of using the enzymatically effective agent in free or in immobilized form for the hydrolysis. Thus, according to the present invention, the hydrolysis can be carried out with dormant cells of bacteria, preferably of Bacillus subtilis. Also, the cells can first be immobilized in a stable inert matrix, and subsequently, the biocatalysts that forms can be used to hydrolyze the galactomannan. According to the present invention, the enzymes and the bacteria, but also the raw extract can be immobilized. The immobilization can be carried out by binding the substances to substrates, by crosslinkage, by inclusion, or by encapsulation. Crosslinkage can be carried out, for example, by means of glutaraldehyde. Binding to the substrate can be carried out by means of adsorptive binding or covalent binding, while for the inclusion, for example, semipermeable membranes in the form of gels, microcapsules, or fibers can be used. Encapsulated enzymes or microorganisms are separated from the surrounding substrate and product solution by means of a semipermeable membrane.

The present invention also relates to a previously mentioned process in which the mixture of mannose- and galactose-containing oligosaccharides obtained is subjected to a chromatographic separating process by means of which the desired oligosaccharides with a specific degree of polymerization can be obtained.

Further advantageous embodiments of the invention are given in the subordinate claims.

This invention will be explained in great detail on the basis of the following examples:

### EXAMPLE 1

### Production of the Biocatalyst

A subculture of the strain Bacillus subtilis SZ 100 (DSM 13182) from a slant agar culture is introduced into a shaking flask with a medium consisting of casein peptone (15/g/L [sic]), soy peptone (5/g/L), NaCl (5/g/L), and guar gum (1/g/L) and incubated for 24 h while shaking at 30° C.

Subsequently, the shake culture is transferred into a 10-L fermenter and further cultivated in a medium that has the same composition as the shake culture.

After 24 h of growth, the cells are centrifuged off, resuspended in a 3% sodium alginate solution, and subsequently added dropwise while stirring into a 2% calcium chloride solution. The calcium alginate pellets (biocatalyst) which formed and which contain Bacillus subtilis (DSM 13182) cells are washed, dried, and stored in a cool place.

### EXAMPLE 2

### Hydrolysis of the Guar Gum

The biocatalyst which is produced as described in Example 1 is allowed to swell in an aqueous guar gum solution (constituents 1 to 5%) and transferred into a column heated to 37° C. The hydrolysis of the guar gum is carried out continuously by passing a guar gum solution through the column. The passing solution is analyzed by means of HPLC for its content of mono-, oligo-, and polysaccharides and the following composition is obtained:

| | |
|---|---|
| Monosaccharides | 2% |
| Oligosaccharides | 70% |
| Polysaccharides | 28% |

The hydrolysis can also be carried out semicontinuously or in batches. For the latter, the biocatalyst produced as described in Example 1 is brought into contact with a guar gum solution in a stirred reactor.

To carry out the hydrolysis, it is also possible to use an raw enzyme extract from Bacillus subtilis (DSM 13182). In this case, after fermentation, the biomass is isolated by means of centrifugation, it is resuspended in a phosphate buffer, and subsequently decomposed (ultrasound, French press, ball mill, etc.). The cellular debris is removed by means of centrifugation, and the raw extract thus obtained is added without further purification to the guar gum solution that is to be hydrolyzed.

In addition to the desired galactomanno-oligosaccharides with a DP of <15, in particular a DP of 2 to 7, the aqueous solution obtained after each hydrolysis also contains a small quantity of higher-molecular components. These can be very easily removed by means of substantially known separating methods, such as chromatography on calcium-loaded highly acid cation exchangers or fractionated alcoholic precipitation or ultrafiltration so that the galactomanno-oligosaccharides with a DP of <15, in particular a DP of 2 to 7, are obtained in pure form in an aqueous solution from which they can be obtained in dry form using substantially known methods (for example, by means of spray drying).

### EXAMPLE 3

### Stability of the Galactomanno-Oligosaccharides in the Mouth, Stomach, and Small Intestine

Stability in the Mouth:

The stability of the oligosaccharides obtained as described in Example 2 against the flora in the mouth was investigated using the bacterial strains Streptococcus mutans DSM 20523 and Streptococcus sobrinus NCTC 10922 which are present in the oral region as well as fresh tooth plaque.

Streptococcus mutans and Streptococcus sobrinus were cultivated for 24 h in liquid DSM medium 92 under anaerobic conditions at 37° C. At the end of the logarithmic growth phase, the cells were centrifuged off (15 min, 4000×g) and resuspended in 10% of the original 20 mM carbonate buffer, pH 7.5. Subsequently, 9 mL of a solution of the oligosaccharides according to the present invention (1% in 20 mM carbonate buffer, pH 7.5) were inoculated with 1 mL of the bacterial suspension and incubated for 2 h at 37° C. Samples were taken at certain intervals and tested for their oligosaccharide content (result see below):

Plaque samples were obtained from three male volunteers who had not brushed their teeth for three days, and in each case, 10 mg of the plaque were suspended in 1 mL of oligosaccharide solution (1% in 20 mM carbonate buffer, pH 7.5). In the course of the two-hour-long incubation time at 37° C., samples were taken and tested for their oligosaccharide content.

Result:

While the saccharose which had been used as a control was completely hydrolyzed within 120 min both by the two streptococci strains and by the mixed culture of the plaque, a cleavage of the oligosaccharides according to the present invention was not observed even after 2 hours.

Stability in the Stomach:

The stability of a substance during passage through the stomach can be demonstrated by means of determining the hydrolysis rate at pH 1.0 and 2.0 and can be compared to saccharose which is used as a control:

For this purpose, 1% galactomanno-oligosaccharide solutions were incubated for 3 h at a pH value of 1.0 (0.1 M HCl) and a pH value of 2.0 (0.01 M HCl) and a temperature of 37° C. After 60, 120, and 180 min, samples were taken from the reaction batch and analyzed by means of HPAEC. The control substances used were saccharose and 1-kestose.

TABLE I

| | | ⁵Inkubationszeit [Min] | | |
|---|---|---|---|---|
| Substanz¹ | pH | 60 | 120 | 180 |
| Saccharose² | 1 | 24 | 55 | 61 |
| | 2 | 1 | 2 | 7 |
| 1-Kestose³ | 1 | 90 | 100 | 100 |
| | 2 | 16 | 30 | 43 |
| Galacto-Manno- | 1 | <1 | <1 | <1 |
| Oligos⁴ | 2 | <1 | <1 | <1 |

Results: Hydrolysis rate in %:
Key:
¹Substance
²Saccharose
³1-Kestose
⁴Galactomanno-oligosaccharides
⁵Incubation time (min)

Table I shows that the galactomanno-oligosaccharides are able to pass through the stomach without sustaining any damage.

Stability Against Pancreatic Enzymes

The pancreatic secretion contains a large number of hydrolases, including carbohydrate-cleaving enzymes, such as α-amylase which cleave α-1,4-glucans (starch, glycogen) preferably to maltose and malto-oligosaccharides.

The stability of galactomanno-oligosaccharides against pancreatic enzymes was tested as follows:

Solutions Required:

20 mM Na phosphate buffer, pH 7.0, plus 6 mM NaCl (solution 1)

1% starch solution (soluble starch according to Zulkowski) in solution 1

1% galactomanno-oligosaccharide solution in solution 1

0.2% pancreatin (firm of Sigma) dissolved in solution 1

TABLE II

| Komponenten¹ | Probe² | Kontrolle³ |
|---|---|---|
| ⁴Galacto-Manno-Oligosac- | 3.0 ml | — |
| charid-Lösung | | |
| ⁵Stärke-Lösung | — | 3.0 ml |
| ⁶Enzymlösung | 0.1 ml | 0.1 ml |

Reaction batches:
Key:
¹Components
²Sample
³Control
⁴Galactomanno-oligosaccharide solution
⁵Starch solution
⁶Enzyme solution

After an incubation time of 210 min in the thermomixer (interval shaking) at 37° C., the reaction was terminated by heating for 15 min to 95°, and the samples were analyzed by means of HPAEC. Prior thereto, the starch-containing sample was completely hydrolyzed by heating it in 1 M HCl at 95° C.

TABLE III

| Substanz¹ | ²Abbaurate (%) |
|---|---|
| Stärke³ | 77 |
| Galacto-Manno-Oligosaccharide⁴ | 0 |

Results:
Key:
¹Substance
²Decomposition rate (%)
³Starch
⁴Galactomanno-oligosaccharides

Table III shows that the galactomanno-oligosaccharides according to the present invention are not affected by the pancreatic enzymes.

### EXAMPLE 4

### Cleavability by Means of α-Glucosidases of the Small Intestine

In vivo, the enzyme complexes saccharase/isomaltase and glucoamylase/maltase which are present in the mucous membranes of the small intestine ensure that after their passage into the small intestine, the disaccharides maltose and saccharose and in part also the malto-oligosaccharides are cleaved to form monosaccharides and as such are able to reach the circulatory system via the intestinal wall.

The stability of the galactomanno-oligosaccharides according to the present invention against these enzymes was tested as follows:

Enzyme Isolation:

The enzyme complexes saccharase/isomaltase (SI complex) and glucoamylase/maltase (GM complex) were isolated from the thin intestine of pigs using the method described by H. Heymann (dissertation, Hannover, 1991).

The cleavability of the galactomanno-oligosaccharides according to the present invention by means of a-glucosidases present in the small intestine was determined as follows:

Solutions Required:

Triethanolamine (TRA) buffer, 0.1 M, pH 7.0

Galactomanno-oligosaccharides, 1% solution in TRA buffer

Maltose and saccharose as control substances, 1% in TRA buffer

Enzyme in the mucous membranes, dissolved in TRA buffer

Reaction Batch:

At t=0, 0.7 U of the enzyme complex saccharase/isomaltase or glucoamylase/maltase were added to 1.2 mL of the carbohydrate solution which had been heated to a temperature of 37° C., mixed, and incubated at 37° C. The reaction was stopped after 2 h by heating the mixture for 15 min to 95° C. The monosaccharides formed as well as the test substances used were quantitatively determined by means of HPAEC.

TABLE IV

| Kohlenhydrat¹ | ²Enzymkomplex | ³Hydrolyserate (%) |
|---|---|---|
| ⁴Saccharose | SI | 98 |
| ⁵Maltose | SI | 95 |
| ⁶Maltose | GM | 96 |
| ⁷Galacto-Manno-Oligos. | SI | <1 |
| ⁸Galacto-Manno-Oligos. | GM | <1 |

Results:
Key:
¹Carbohydrate
²Enzyme complex
³Hydrolysis rate (%)
⁴Saccharose
⁵Maltose
⁶Maltose
⁷Galactomanno-oligosaccharides
⁸Galactomanno-oligosaccharides

The results show that under the chosen conditions of a nearly complete hydrolysis of saccharose and maltose in the case of the SI enzyme complex and of maltose in the case of the GM enzyme complex, the galactomanno-oligosaccharides are practically not cleaved by either of the enzyme complexes.

### Cleavability by Means of Isolated Enzyme Complexes (SI Complex and GM Complex)

The enzyme complexes saccharase/isomaltase (SI complex) and glucoamylase/maltase (GM complex) which were isolated from the small intestine of pigs (see Example 4) were tested for inhibition with the galactomanno-oligosaccharides according to the present invention in the presence of the substance saccharose and maltose in the case of the SI complex and of maltose in the case of the GM complex. The ratio between substrate and inhibitor was in all cases 10:1.

| | |
|---|---|
| Batch: | −0.7 mL of substrate solution, 1.43% in 0.1 M |
| | Na phosphate buffer, pH 7.0 |
| | −0.1 mL of galactomanno-oligosaccharides, 1% |
| | −0.1 mL of 0.1 M Na phosphate buffer, pH 7.0 |
| Preliminary incubation: | 15 min, 37° C. |
| | Collection of the null sample |
| Start: | 0.1 mL of enzyme solution (0.5 U/mL of |
| | maltase activity in the initial batch) |
| Sample collection: | 0.15 mL of sample after 30 and 60 min each |
| Termination of | 2 min at 95° C. |
| the reaction: | |
| Analysis: | HPAEC, standard solution 10 ppm each of |
| | glucose, fructose, 20 ppm each of saccharose, |
| | maltose |

TABLE V

Inkubationsdauer²

| % Inhibierung¹ | 30 Min. | 60 Min. |
|---|---|---|
| SI/Saccharose | 24 | 25 |
| SI/Maltose | 26 | 18 |
| GM/Maltose | 0 | 0 |

Results:
Key:
¹% Inhibition
²Incubation time

As Table V indicates, the cleavage of saccharose and maltose by the SI enzyme complex is inhibited in the presence of galactomanno-oligosaccharides. The maltose cleavage by the GM complex, on the other hand, is not influenced when galactomanno-oligosaccharides are added.

### EXAMPLE 6

### Preventing the Adhesion of Pathogenic Microorganisms to Epithelial Cells

Epithelial Cells

Human uroepithelial cells obtained by means of centrifugation from first morning urine

Microorganisms

Staphylococcus aureus, 2 strains, and E. coli, 2 strains, each as suspension with 10⁹ microorganisms/mL

Test

The epithelial cells and the suspension of microorganisms were combined and incubated for 30 min at 37° C. Subsequently, the epithelial cells were separated from the nonadherent microorganisms by means of membrane filtration (8 μ). The filters were repeatedly washed and placed into physiological saline solution, and the epithelial cells were suspended in said solution. After centrifuging the suspension in saline solution, the pellet was placed on a microscopic slide and stained according to May-Grünwald and Giemsa. The number of the microorganisms adhering to 50 epithelial cells as counted. The number represented the blank reading. Epithelial cells without the addition of a suspension of microorganisms served as the control.

In the main test, epithelial cells were first incubated for 1, 2, and 3 h with galactomanno-oligosaccharide solutions of different concentrations. They were subsequently combined with the suspension of microorganisms and treated as described above. The number of microorganisms adhering to 50 epithelial cells represented the measured value.

Result:

In the case of the “neutral” carbohydrates which were used for the purpose of comparison, for example, raffinose, nystose, and isomelzitose, the number of microorganisms adhering to the epithelial cells was not reduced. The galactomanno-oligosaccharides according to the present invention, on the other hand, almost completely prevented an adhesion of all microorganisms tested (blockage: >95%).

### EXAMPLE 7

### Increase in the Mucus Secretion in the Colon

After thoroughly cleaning the resected colon of a freshly slaughtered pig, pieces measuring 1 cm² were cut from the distal segment of said colon. The pieces thus prepared were incubated, while stirring and fumigating with oxygen, for 5 h at a temperature of 37° in Hanks buffer to which chloramphenicol and ampicillin (50 μg/mL each) had been added. The buffer additionally contained 1% of the galactomanno-oligosaccharides produced according to the present invention and to be tested for their stimulating effect on the mucus secretion. As a control, 10 colon segments were used in each batch to be tested. One of the batches contained hydrocortisone which is normally used in the treatment of inflammatory intestinal diseases.

As a measure for an increase in the mucus secretion, the increase in the total carbohydrate content in the supernatant portion was measured. For this purpose, during the incubation, samples were collected at various times, and 20 μL of resorcin solution (6 mg/mL) and 100 μL of 75% sulfuric acid were added to 10 μL of each sample, and after an incubation time of 60 min at 80° C., the extinction was measured at λ=450 nm.

Result:

When compared to the control, the galactomanno-oligosaccharides according to the present invention cause an approximately 2.4-fold increase in the mucus secretion, while the hydrocortisone leads to an approximately 5.3-fold increase. In recent studies, it was found that in cell cultures obtained from biopsies of epithelial cells of the colon, substances, such as corticosteroids, are able to stimulate the endogenic mucus secretion (I. A. Finnie et al., Clinical Science 91 (1996), pp. 359-364). Thus, there is a possibility of favorably influencing inflammatory intestinal disease with food components which consist of galactomanno-oligosaccharides according to the present invention.

### EXAMPLE 8

### Influence on the Microflora in the Colon

To investigate the influence of the galactomanno-oligosaccharides according to the present invention on the composition of the microflora in the colon, a number of pure cultures of bacteria present in human feces were cultivated in the following medium with galactomanno-oligosaccharides as the only carbon source:

| | | |
|---|---|---|
| Trypticase/tryptone | 1.50 | g |
| Yeast extract | 1.00 | g |
| KH₂PO₄ | 0.24 | g |
| Na₂HPO₄ | 0.24 | g |
| (NH₄)₂SO₄ | 1.24 | g |
| NaCl | 0.48 | g |
| MgSO₄.7H₂O | 0.10 | g |
| CaCl₂.2H₂O | 0.06 | g |
| FeSO₄.7H₂O | 2 | mg |
| Resazurin | 1 | mg |
| Cysteine/HCl | 0.50 | g |
| Vitamin solution (according to DSM 141) | 0.50 | mL |
| Trace element solution (according to DSM 141) | 9.00 | mL |
| NaHCO₃ | 2.00 | g |
| Galactomanno-oligosaccharides | 5.00 | g |
| Distilled H₂O to make up 1000 mL, pH 7.0 | | |

The Test was Carried out With the Following Microorganisms

Bacteroides asaccharolyticus

Bacteroides distasonis

Bacteroides fragilis

Bacteroides tetaiotaomicron

Bifidobacterium adolescentis

Bifidobacterium bifidum

Bifidobacterium breve

Bifidobacterium infantis

Bifidobacterium longum

Eubacterium lentum

Eubacterium limosum

Lactobacillus casei

Lactobacillus fermentum

Clostridium butyricum

Clostridium difficile

Clostridium perfiingens

Enterobacter cloacae

Escherichia coli

Klebsiella pneumoniae

Salmonella typhimurium

Serratia marcescens

Staphylococcus aureus

Each of the microorganisms was cultivated for 24 h at 37° C. under anaerobic conditions. Throughout the experiment, samples were collected at specific times and tested for pH value and oligosaccharide concentration. In addition, the increase in the number of cells was determined by means of optical density measurements.

Only the bifidobacteria and the two lactobacilli were able to metabolize the galactomanno-oligosaccharides according to the present invention and grow on them. With all of the other bacteria tested, no growth was observed on the medium. This indicates that food products which contain the galactomanno-oligosaccharides according to the present invention can change the composition of the microflora in the colon in a positive manner.

### EXAMPLE 9

### Strengthening the Immunodefensive System

Strengthening the Phagocytosis

The influence of the galactomanno-oligosaccharides according to the present invention on the function of the phagocytes (mono-, granulocytes) can be determined by means of phagocytosis assays. During the phagocytosis stimulation, the phagocytes were first incubated with galactomanno-oligosaccharides (100 μg of glycan/0. 11 mL of whole blood, 37° C., 10 min). A corresponding blank was incubated for 10 min in an ice bath. Subsequently, the actual phagocytosis test was carried out under the following conditions:

0.11 mL of the preliminary incubation solution was allowed to stand for 10 min in the ice bath; subsequently, 0.01 mL of nonopsonized E. coli (fluorescein isothiocyanate (FITC) marked, 10⁹ per mL, ORPEGEN) or 0.01 mL of nonopsonized Staphylococcus aureus (15×10⁶ per mL, FITC marked, MOLECULAR PROBES) were added. The batches were incubated (double determinations) for 10 min at 37° C. The batches were washed twice with 3 mL of washing buffer (ORPEGEN) each and centrifuged at 250×g for 5 min at 4° C.

The lysis of the erythrocytes in the sediment was carried out for 20 min with 2 mL of lysis buffer (ORPEGEN) at room temperature, and subsequently the batch was washed once. 0.2 mL of DNA staining solution (propidium iodide) were added to the sediment and allowed to stand for 10 min in the ice bath.

The measurement was carried out in the flow cytometer (excitation: 488 nm, emission FL-1: 520 nm); monocytes and granulocytes can be distinguished from each other without separation (forward light scatter (FSC) versus (ESC) (sideways light scatter). The results are expressed as a percentage of the phagocytosis-positive cells (see Table VI below).

The control substance without phagocytosis effect used was raffinose.

TABLE VI
¹Einfluss von Galacto-Manno-Oligosacchariden (100 μg/Ansatz)

| | Monocyten³ | Granulocyten⁴ | |
|---|---|---|---|
| | (% positive Zellen) | (% positive Zellen) | |
| | E. coli | E. coli | Staph. aureus |
| Zelltyp² | nicht | nicht | nicht |
| Bakterienart⁵ | opsoniert⁶ | opsoniert⁶ | opsoniert⁶ |
| ⁷Kontrolle 4° C. | 8.0 | 1.0 | 0.5 |
| ⁸Kontrolle 37° C. | 21.5 | 19.5 | 27.0 |
| ⁹Galacto-Manno- | 35.0 | 33.5 | 42.5 |
| Oligos. | | | |
| ¹⁰Raffinose | 22.0 | 17.0 | 30.0 |

Phagocytossis assay
Key:
¹Influence of galactomanno-oligosaccharides (100 μg/batch)
²Cell type
³Monocytes (% of positive cells)
⁴Granulocytes (% of positive cells)
⁵Type of bacteria
⁶Nonopsonized
⁷Control 4° C.
⁸Control 37° C.
⁹Galactomanno-oligosaccharides
¹⁰Raffinose

The results show that after a preliminary incubation of the mono and granulocytes with the galactomanno-oligosaccharides according to the present invention, phagocytosis was stimulated.

Adhesion Assay

In the adhesion assay, the influence of galactomanno-oligosaccharides according to the present invention on the adhesion of B cell lines (for example, Reh) and normal human B lymphocytes to epithelial cells (colon tumor line HT 29) was measured. In the overlay assay used, the lymphocytes were intracellularly marked with calcein so as to make it possible to carry out the measurement by means of fluorometry.

First, coating with the adherent colon epithelial cell one (HT 29) in microtiter plates (24-hole Costar® plates) took place, with incubation (37° C., overnight) until a confluent bed has formed. This is done as much as possible in a serum-free medium Inoculum: 1×10⁴ cells. Before the subsequent assay was carried out, the adherent cells were washed three times with PBS(phosphate-buffered physiological saline solution) and blocked for 1 h at room temperature with PBS+1% bovine serum albumin (BSA).

The untreated B cell lines or isolated B lymphocytes to be tested were marked with fluorescent calcein (1×10⁷ cells in 2 mL of RPMI medium+HEPES+10 μL of calcein AM, 30 min, 37° C.; subsequently washed 2× with HBSS (Hanks buffer)+0.25% BSA) and 1×10⁶ cells in 0.5 mL of PBS+0.25% HBSS per hole were incubated for 1 h. The culture plate was placed on a shaker for 10 sec, 0.5 mL of 0.2% glutaraldehyde in PBS+0.2% BSA per hole were added and incubated for 10 min on the shaker. The fluorescence of the plate was measured in a fluorescence measuring device (494, 517 min).

The first measurement corresponds to the 100% value. Subsequently, the plate was washed four times and again measured. This measurement corresponds to the specific adhesion which is expressed as a percentage of the 100% value minus the autofluorescence value (unmarked cells). The control substances used were galactose and glucose.

Adhesion of Reh(pre-B) on the Colon Cell Line HT 29

TABLE VII

| Zucker¹ | Mittelwert (%)² | SD³ | Index⁴ |
|---|---|---|---|
| ⁵Ohne Kohlenhydrat | 46 | 6.3 | 1.00 |
| ⁶D-Glucose | 47 | 6.0 | 1.11 |
| ⁷D-Galactose | 51 | 7.0 | 1.12 |
| ⁸Galacto-Manno- | 93 | 9.7 | 2.02 |
| Oligosaccharide | | | |

Influence of galactomanno-oligosaccharides (10 μg/batch)
Key:
¹Sugar
²Mean value (%)
³SD
⁴Index
⁵Without carbohydrate
⁶D-Glucose
⁷D-Galactose
⁸Galactomanno-oligosaccharides

In the presence of the galactomanno-oligosaccharides, the B cell lines (Reh) adhered to a considerably greater extent to the colon cell line HT 29 when compared to the control substances D-glucose and D-galactose.

### EXAMPLE 10

### Improvement of the Calcium Absorption

Preparation of the Test:

Male Sprague-Dawley rats, each weighing approximately 100 g, were kept with free access to demineralized water for a habituation period of 4 days while being fed the following standard diet:

| | | |
|---|---|---|
| Casein | 250 | g |
| Corn oils | 50 | g |
| Mixture of mineral salts (free of Ca and Fe) | 25 | g |
| Calcium carbonate | 7.5 | g |
| Vitamin mixture | 10 | g |
| Vitamin E | 1 | g |
| Choline bitartarate | 4 | g |
| Saccharose | to make up 1000 | g |

Subsequently, the rats were assigned to two groups. In the first group, the complete stomach of the animals was removed (stomach resection group); the second group served as the control (control group). After the operation, food and water was withheld from the rats for 24 h, thereafter they received cow's milk for 2 to 3 days, and subsequently they were fed 14 to 16 days with the standard diet for a habituation phase of 4 days.

Test

Subsequently, each test group was again divided into two groups. One subgroup each continued to be fed the standard diet while the other subgroup received a diet with the addition of galactomanno-oligosaccharides (50 g/kg diet). Over a test period of 3 weeks, feces samples were collected beginning on the third day and tested for excreted calcium. At the end of the test, the content of the cecum was analyzed.

Results:

With the standard diet, the calcium absorption in the stomach resection group was only approximately one fourth of the calcium absorption in the control group.

By adding the galactomanno-oligosaccharides according to the present invention, it was possible to double the calcium absorption in the stomach resection group, thereby increasing it to approximately 50% of that in the control group:

In the rats receiving the diet containing the galactomanno-oligosaccharides according to the present invention, an analysis of the cecum content showed that the propionic acid concentration was considerably increased. This correlates significantly with the measured calcium absorption.

1. A method for the production of mannose- and galactose-containing oligosaccharides from galactomannans, according to which an aqueous solution or suspension of the galactomannan is produced, which is hydrolyzed by means of an enzymatically effective agent obtained from bacteria, and an aqueous solution of a mixture of mannose- and galactose-containing oligosaccharides with a degree of polymerization (DP) of <15 is obtained.

2. The method as claimed in claim 1, wherein the degree of polymerization (DP) is 2 to 7.

3. The method as claimed in claim 1 or 2, wherein the bacteria are bacteria of the Bacillus subtilis type.

4. The method as claimed in one of claims 1 through 3, wherein the bacteria are bacteria of the strain deposited with DSM under accession No. 13182.

5. The method as claimed in any one of claims 1 through 4, wherein the enzymatically effective agent constitutes live or dead cells of bacteria.

6. The method as claimed in any one of claims 1 through 4, wherein the enzymatically effective agent is a galactomannan-hydrolyzing enzyme from bacteria or a raw extract from cells of bacteria.

7. The method as claimed in any one of claims 1 through 6, wherein the enzymatic hydrolysis is carried out with immobilized cells, immobilized raw extracts, or immobilized enzymes of bacteria.

8. The method as claimed in any one of the preceding claims, wherein the mixture of mannose- and galactose-containing oligosaccharides obtained is subjected to a chromatographic separating process.

9. A galactomanno-oligosaccharide which can be produced according to one of the methods indicated in claims 1 through 8, comprising β-1,4-linked mannose units and galactose units linked to α-1,6 with a degree of polymerization (DP) of <15, in particular of 2 to 7.

10. A galactomanno-oligosaccharide which can be produced according to one of the methods indicated in claims 1 through 8, comprising β-1,4-linked mannose units and galactose units linked to α-1,6 with a degree of polymerization (DP) of <15, in particular of 2 to 7, for use as a therapeutic or diagnostic agent.

11. An enzyme with the ability to hydrolyze galactomannan, which can be produced from the Bacillus subtilis strain DSM 13182.

12. A raw extract with the ability to hydrolyze galactomannan, which can be produced by means of a disruption of cells of bacteria of the Bacillus subtilis strain DSM 13182.

13. The Bacillus subtilis strain DSM 13182.

14. Drugs containing a galactomanno-oligosaccharide as claimed in claim 9, optionally combined with a pharmaceutically compatible vehicle.

15. Food products or “enjoyment products” containing a galactomanno-oligosaccharide as claimed in claim 9.

16. The use of a galactomanno-oligosaccharide as claimed in claim 9 for use in the production of “enjoyment products” and/or food products and/or for lowering the glycemic index of “enjoyment products” and/or food products.

17. The use of the galactomanino-oligosaccharide as claimed in claim 9 or of a food product containing this galactomanno-oligosaccharide for preventing infectious diseases, for preventing intestinal diseases, for preventing colon carcinogenesis, for strengthening the immunodefensive system against general infections, for preventing inflammatory diseases and/or for preventing osteoporosis.

18. The use of the galactomanno-oligosaccharide as claimed in claim 9 for use in the production of a drug for preventing infectious diseases, for preventing intestinal diseases, for preventing colon carcinogenesis, for strengthening the immunodefensive system against general defects, for preventing inflammatory diseases and/or for preventing osteoporosis.
